(19) United States
(12) Patent Application Publication
(10) Pub. No.: US 2008/0283400 A1
(43) Pub. Date: Nov. 20, 2008

(54) Separation Medium for Use in Chromatography

(75) Inventors: Dirk John Broer, Geldrop (NL); Emiel Peeters, Eindhoven (NL); Ralph Kurt, Eindhoven (NL); Roel Penterman, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/096,918

(22) PCT Filed: Nov. 28, 2006
(86) PCT No.: PCT/IB2006/054485

§ 371 Date: Jun. 11, 2008

(30) Foreign Application Priority Data
Dec. 12, 2005 (EP) 05111940.2

(51) Int. Cl. G01N 27/26; G01N 27/00

(52) U.S. Cl. 204/459; 204/610

(57) ABSTRACT

The invention relates to a separation medium for chromatography which is structured in that way that the flow rate is in one preselected direction larger than perpendicular to that direction.

The present invention is directed to the field of devices for chromatography, especially gel electrophoresis of biomolecules.

Chromatography, especially electrophoresis of biomolecules usually takes place in a gel-like substrate medium which is in most cases made “in situ” e.g. by polymerization of acryl and bisacryl in aqueous media shortly before the separation takes place.

However, especially for gel electrophoresis, the results of the chromatography sometimes lack reliability due to the non-structured nature of the separation medium. During analysis, the substances tend to appear not in well-defined bands, but have “noses” and “edges”, which reduce the analysis accuracy, especially when several biomolecules which have only small differences e.g. in the isoelectric point or the weight are to be separated.

It is therefore an object of the present invention to provide a separation medium, which allows a more reliable chromatography of biomolecules.

This object is solved by a separation medium according to claim 1 of the present invention. Accordingly, a separation medium for use in chromatography, especially gel electrophoresis is provided, whereby the separation medium is an essentially two-dimensional material which is at least partly structured in that way that in a preferred flow direction the flow rate is larger than perpendicular to said preferred flow direction.

By using such a separation medium, for most applications at least one of the following advantages can be achieved:

The chromatography is more controlled, therefore the reliability of the chromatography is enhanced.

The amount of material needed for the chromatography can be reduced and the resolution increased.

The location of the separated species is better defined. Therefore, read-out by a pixelated electro-optical system such as a CCD camera becomes better defined. In other words voxels (=volume pixels) in the chromatographic medium correlate with the pixels on the camera sensor).

The term “two-dimensional material” means and/or includes especially that the thickness of the separation medium in one dimension is >0% and ≦35% than in either one of the other dimensions.

According to an embodiment of the present invention, the separation medium is a porous and/or elastic material.

The term “porous material” means and/or includes especially that types of materials that are transparent for material flow or material diffusion such that the interaction with the material to be separated is species-specific giving different flow rates for different species.

According to an embodiment of the present invention, the porous material can be polymer gel like structure such that the polymer chains are swollen in a liquid such as water, leaving space or pores in between the polymer chains to allow materials transport. According to an embodiment of the present invention, the combination of crosslink density of the polymer together with its physical interaction with the liquid determines in this case the pore size.

According to an embodiment of the present invention, the porous material is a pre-structured polymer or inorganic materials of which the pores are determined by lithographic means.

According to an embodiment of the present invention, the porous material is an assembly of structures, such as polymer spheres, brought in close contact with each other such that the pore size is determined by the shape and size of the structures.

The term “flow rate” means and/or includes especially the transport rate, e.g. expressed in m/s, by which a species travels through the porous medium. It should be noted that this may mean and/or include various origins of transport such as transport of species caused by the hydrodynamic forces of a streaming liquid (eluent) that fills the medium by capillary forces or by a liquid that is pumped through the membrane under pressure.

In the sense of the present invention, the term “flow rate” means and/or includes especially the rate that (at least on of) the bio species travel in the separation medium expressed in ms⁻¹.

For most applications within the present invention, one way of measuring and/or obtaining average flow rate (or for the rate of the fastest flowing parts in the analyte) can be obtained by means of a tracking dye, e.g. an organic fluorescent dye. This dye can be added to the gel as such or can be part of the bio samples. E.g. the dye can be blended with the DNA sample. The flow of the dye can for most applications be recorded by different means:

by eye and a ruler; this provides an easy accessible indication of the flow rate just by measuring time that it takes for the dye to travel over a typical distance e.g. 1 cm. This is especially suitable to measure the flow rate in the preferential direction of the device.

by microscope, e.g. with a distance indication in the ocular. This is convenient to measure the flow rate in the non-preferential dimensions to measure the ratio between forwards and sideway flow. A simple experiment would be to see whether the dye has passed the barrier between the channels.

by CCD camera. This is of course the most convenient method, as it is a digitized method, which can be automated.

In literature various tracking dyes are described. Examples are bromophenol blue, bromophenol blue sodium salt and bromocresol green.

In some applications it is also feasible to measure the flow ratio between the preferred flow direction and the direction perpendicular to in that also two (or more) different test fluids are be applied. If e.g. to the flow in a first channel a red dye is added whereas in the neighbouring channel a green dye is added, one can measure the time (or the lateral distance if the flow rate in the preferred direction is known) it takes to mix these two fluids (observing a yellow region). The same principle can also be applied using fluorophores corresponding quenching particles in the second flow.

According to an embodiment of the present invention, the flow is at least partly caused by the presence of an electrical field that enforces the species to flow because of their surface charges (electrophoresis). In that case the species will flow within a stationary liquid. Also combinations of effects can be thought of and are within the scope of the present invention.

According to an embodiment of the present invention, the separation medium is in ≧60% and ≦100% of its total area structured in that way that in a preferred flow direction the flow rate is larger than perpendicular to said preferred flow direction.

According to an embodiment of the present invention, the separation medium is in ≧70% and ≦100% of its total area structured in that way that in a preferred flow direction the flow rate is larger than perpendicular to said preferred flow direction.

According to an embodiment of the present invention, the separation medium is in ≧80% and ≦100% of its total area structured in that way that in a preferred flow direction the flow rate is larger than perpendicular to said preferred flow direction.

According to an embodiment of the present invention, the separation medium is an essentially two-dimensional material which is at least partly structured in that way that in a preferred flow direction the flow rate is larger than in any direction with an angle of ≧85° and ≦95° to said preferred flow direction.

According to an embodiment of the present invention, the separation medium is in ≧60% and ≦100% of its total area structured in that way that in a preferred flow direction the flow rate is larger than in any direction with an angle of ≧85° and ≦95° to said preferred flow direction.

According to an embodiment of the present invention, the separation medium is in ≧70% and ≦100% of its total area structured in that way that in a preferred flow direction the flow rate is larger than in any direction with an angle of ≧85° and ≦95° to said preferred flow direction.

According to an embodiment of the present invention, the separation medium is in ≧80% and ≦100% of its total area structured in that way that in a preferred flow direction the flow rate is larger than in any direction with an angle of ≧85° and ≦95° to said preferred flow direction.

According to an embodiment of the present invention, the separation medium is in ≧60% and ≦100% of its total area structured in that way that in a preferred flow direction the flow rate is ≧2 times larger than in any direction with an angle of ≧85° and ≦95° to said preferred flow direction.

According to an embodiment of the present invention, the separation medium is in ≧70% and ≦100% of its total area structured in that way that in a preferred flow direction the flow rate is ≧2 times larger than in any direction with an angle of ≧85° and ≦95° to said preferred flow direction.

According to an embodiment of the present invention, the separation medium is in ≧80% and ≦I100% of its total area structured in that way that in a preferred flow direction the flow rate is ≧2 times larger than in any direction with an angle of ≧85° and ≦95′to said preferred flow direction.

According to an embodiment of the present invention, the separation medium is in ≧60% and ≦100% of its total area structured in that way that in a preferred flow direction the flow rate is ≧2 times larger than in any direction with an angle of ≧75° and ≦105° to said preferred flow direction.

According to an embodiment of the present invention, the separation medium is in ≧70% and ≦100% of its total area structured in that way that in a preferred flow direction the flow rate is ≧2 times larger than in any direction with an angle of ≧75° and ≦105° to said preferred flow direction.

According to an embodiment of the present invention, the separation medium is in ≧80% and ≦100% of its total area structured in that way that in a preferred flow direction the flow rate is ≧2 times larger than in any direction with an angle of ≧75° and ≦105° to said preferred flow direction.

According to an embodiment of the present invention, the separation medium is in ≧60% and ≦100% of its total area structured in that way that in a preferred flow direction the flow rate is ≧2 times and ≦10000 times larger than in any direction with an angle of ≧55° and ≦125° to said preferred flow direction.

According to an embodiment of the present invention, the separation medium is in ≧70% and ≦100% of its total area structured in that way that in a preferred flow direction the flow rate is ≧2 times and ≦10000 times larger than in any direction with an angle of ≧55° and ≦125° to said preferred flow direction.

According to an embodiment of the present invention, the separation medium is in ≧80% and ≦100% of its total area structured in that way that in a preferred flow direction the flow rate is ≧2 times and ≦10000 times larger than in any direction with an angle of ≧25° and ≦155° to said preferred flow direction.

According to an embodiment of the present invention, the separation medium is in ≧60% and ≦100% of its total area structured in that way that in a preferred flow direction the flow rate is ≧4 times and ≦100 times larger than in any direction with an angle of ≧85° and ≦95° to said preferred flow direction.

According to an embodiment of the present invention, the separation medium is in ≧70% and ≦100% of its total area structured in that way that in a preferred flow direction the flow rate is ≧4 times and ≦100 times larger than in any direction with an angle of ≧85° and ≦95° to said preferred flow direction.

According to an embodiment of the present invention, the separation medium is in ≧80% and ≦100% of its total area structured in that way that in a preferred flow direction the flow rate is ≧4 times and ≦100 times larger than in any direction with an angle of ≧85° and ≦95° to said preferred flow direction.

According to an embodiment of the present invention, the separation medium is in ≧60% and ≦100% of its total area structured in that way that in a preferred flow direction the flow rate is ≧4 times and ≦100 times larger than in any direction with an angle of ≧75° and ≦105° to said preferred flow direction.

According to an embodiment of the present invention, the separation medium is in ≧70% and ≦100% of its total area structured in that way that in a preferred flow direction the flow rate is ≧4 times and ≦100 times larger than in any direction with an angle of ≧75° and ≦105° to said preferred flow direction.

According to an embodiment of the present invention, the separation medium is in ≧80% and ≦100% of its total area structured in that way that in a preferred flow direction the flow rate is ≧4 times and ≦100 times larger than in any direction with an angle of ≧75° and ≦105° to said preferred flow direction.

According to an embodiment of the present invention, the separation medium is in ≧60% and ≦100% of its total area structured in that way that in a preferred flow direction the flow rate is ≧4 times and ≦100 times larger than in any direction with an angle of ≧55° and ≦125° to said preferred flow direction.

According to an embodiment of the present invention, the separation medium is in ≧70% and ≦100% of its total area structured in that way that in a preferred flow direction the flow rate is ≧4 times and ≦100 times larger than in any direction with an angle of ≧55° and ≦125° to said preferred flow direction.

According to an embodiment of the present invention, the separation medium is in ≧80% and ≦100% of its total area structured in that way that in a preferred flow direction the flow rate is ≧4 times and ≦100 times larger than in any direction with an angle of ≧55° and ≦125° to said preferred flow direction.

According to an embodiment of the present invention, the separation medium is in ≧60% and ≦100% of its total area structured in that way that in a preferred flow direction the flow rate is ≧4 times and ≦100 times larger than in any direction with an angle of ≧25° and ≦155° to said preferred flow direction.

According to an embodiment of the present invention, the separation medium is in ≧70% and ≦100% of its total area structured in that way that in a preferred flow direction the flow rate is ≧4 times and ≦100 times larger than in any direction with an angle of ≧25° and ≦155° to said preferred flow direction.

According to an embodiment of the present invention, the separation medium is in ≧80% and ≦100% of its total area structured in that way that in a preferred flow direction the flow rate is ≧4 times and ≦100 times larger than in any direction with an angle of ≧25° and ≦155° to said preferred flow direction.

According to an embodiment of the present invention, the separation medium is in ≧60% and ≦100% of its total area structured in that way that in a preferred flow direction the flow rate is ≧10 times and ≦50 times larger than in any direction with an angle of ≧85° and ≦95° to said preferred flow direction.

According to an embodiment of the present invention, the separation medium is in ≧70% and ≦100% of its total area structured in that way that in a preferred flow direction the flow rate is ≧10 times and ≦50 times larger than in any direction with an angle of ≧85° and ≦95° to said preferred flow direction.

According to an embodiment of the present invention, the separation medium is in ≧80% and ≦100% of its total area structured in that way that in a preferred flow direction the flow rate is ≧10 times and ≦50 times larger than in any direction with an angle of ≧85° and ≦95° to said preferred flow direction.

According to an embodiment of the present invention, the separation medium is in ≧60% and ≦100% of its total area structured in that way that in a preferred flow direction the flow rate is ≧10 times and ≦50 times larger than in any direction with an angle of ≧75° and ≦105° to said preferred flow direction.

According to an embodiment of the present invention, the separation medium is in ≧70% and ≦100% of its total area structured in that way that in a preferred flow direction the flow rate is ≧10 times and ≦50 times larger than in any direction with an angle of ≧75° and ≦105° to said preferred flow direction.

According to an embodiment of the present invention, the separation medium is in ≧80% and ≦100% of its total area structured in that way that in a preferred flow direction the flow rate is ≧10 times and ≦50 times larger than in any direction with an angle of ≧75° and ≦105° to said preferred flow direction.

According to an embodiment of the present invention, the separation medium is in ≧60% and ≦100% of its total area structured in that way that in a preferred flow direction the flow rate is ≧10 times and ≦50 times larger than in any direction with an angle of ≧55° and ≦125° to said preferred flow direction.

According to an embodiment of the present invention, the separation medium is in ≧70% and ≦100% of its total area structured in that way that in a preferred flow direction the flow rate is ≧10 times and ≦50 times larger than in any direction with an angle of ≧55° and ≦125° to said preferred flow direction.

According to an embodiment of the present invention, the separation medium is in ≧80% and ≦100% of its total area structured in that way that in a preferred flow direction the flow rate is ≧10 times and ≦50 times larger than in any direction with an angle of ≧55° and ≦125° to said preferred flow direction.

According to an embodiment of the present invention, the separation medium is in ≧60% and ≦100% of its total area structured in that way that in a preferred flow direction the flow rate is ≧10 times and ≦50 times larger than in any direction with an angle of ≧25° and ≦155° to said preferred flow direction.

According to an embodiment of the present invention, the separation medium is in ≧70% and ≦100% of its total area structured in that way that in a preferred flow direction the flow rate is ≧10 times and ≦50 times larger than in any direction with an angle of ≧25° and ≦155° to said preferred flow direction.

According to an embodiment of the present invention, the separation medium is in ≧80% and ≦100% of its total area structured in that way that in a preferred flow direction the flow rate is ≧10 times and ≦50 times larger than in any direction with an angle of ≧25° and ≦155° to said preferred flow direction.

According to an embodiment of the present invention, the separation medium is structured in that way that in the direction of ≧85° and ≦95° to the preferred flow direction alternating areas with a high porosity of ≧10% and ≦99% and/or areas with a low porosity of ≧0% and ≦60% are provided.

According to an embodiment of the present invention, the separation medium is structured in that way that in the direction of ≧75° and ≦105° to the preferred flow direction alternating areas with a high porosity of ≧10% and ≦99% and/or areas with a low porosity of ≧0% and ≦60% are provided.

In the sense of the present invention, the term “porosity” especially means or includes the ratio of the volume of all the pores or voids in a material to the volume of the whole. In other words, porosity is the proportion of the non-solid volume to the total volume of material. In the sense of the present invention porosity is especially a fraction between 0% and 100%.

According to an embodiment of the present invention, the separation medium is structured in that way that in the direction of ≧85° and ≦95° to the preferred flow direction alternating areas with a high porosity of ≧40% and ≦99% and/or areas with a low porosity of ≧5 and ≦40% are provided.

According to an embodiment of the present invention, the separation medium is structured in that way that in the direction of ≧85° and ≦95° to the preferred flow direction alternating areas with a high porosity of ≧60% and ≦99% and/or areas with a low porosity of ≧10 and ≦30% are provided.

According to an embodiment of the present invention, the separation medium is structured in that way that in the direction of ≧75° and ≦105° to the preferred flow direction alternating areas with a high porosity of ≧40% and ≦99% and/or areas with a low porosity of ≧5 and ≦40% are provided.

According to an embodiment of the present invention, the separation medium is structured in that way that in the direction of ≧75° and ≦105° to the preferred flow direction alternating areas with a high porosity of ≧60% and ≦99% and/or areas with a low porosity of ≧10 and ≦30% are provided.

According to an embodiment of the present invention, the areas with a high porosity form essentially parallel channels and/or the areas with a low porosity form walls.

According to an embodiment of the present invention, the width of the channels is ≧1 μm and ≦1000 μm. According to an embodiment of the present invention, the width of the channels is ≧10 μm and ≦500 μm. According to an embodiment of the present invention, the width of the channels is ≧50 μm and ≦200 μm.

According to an embodiment of the present invention, the height of the channels is ≧0.5 μm and ≦500 μm. According to an embodiment of the present invention, the width of the channels is ≧2 μm and ≦250 μm. According to an embodiment of the present invention, the width of the channels is ≧5 μm and ≦100 μm.

According to one embodiment of the present invention, the channels have in cross-sectional view a rectangular profile.

It should be noted that in case the channels have in cross-sectional view a non-rectangular and/or not essentially rectangular profile, the terms “width” and “height” mean or include especially the maximum width and height of the channel.

According to one embodiment of the present invention, the channels have in cross-sectional view a triangular profile, according to one embodiment of the present invention, the channels have in cross-sectional view a conical profile, According to one embodiment of the present invention the channels have in cross-sectional view a trapezoid profile.

According to an embodiment of the present invention, the thickness of the walls is ≧100 nm and ≦200 μm. According to an embodiment of the present invention, the thickness of the walls is ≧1 μm and ≦100 μm. According to an embodiment of the present invention, the thickness of the walls is ≧10 μm and ≦50 μm.

According to an embodiment of the present invention, the number of channels per mm of separation medium in cross sectional-view along an angle of ≧85° and ≦95° to the preferred flow direction is ≧2 and ≦500.

According to an embodiment of the present invention, the number of channels per mm of separation medium in cross sectional-view along an angle of ≧85° and ≦95° to the preferred flow direction is ≧4 and ≦300.

According to an embodiment of the present invention, the number of channels per mm of separation medium in cross sectional-view along an angle of ≧85° and ≦95° to the preferred flow direction is ≧5 and ≦200.

According to an embodiment of the present invention, the separation medium comprises a polyacrylic material.

According to an embodiment of the present invention, the separation medium comprises a polyacrylic material made out of the polymerization of at least one acrylic monomer and at least one polyfunctional acrylic monomer.

The monomers are according to an embodiment selected from a range such that the polymers formed thereof easily takes up water to form a swollen medium.

According to an embodiment of the present invention, the acrylic monomer is chosen out of the group comprising acrylamide, acrylic acid, hydroxyethylacrylate, ethoxyethoxyethylacrylate or mixtures thereof.

According to an embodiment of the present invention, the polyfunctional acrylic monomer is a bis-acryl and/or a tri-acryl and/or a tetra-acryl and/or a penta-acryl monomer.

According to an embodiment of the present invention, the polyfunctional acrylic monomer is chosen out of the group comprising bisacrylamide, tripropyleneglycol diacrylates, pentaerythritol, triacrylate or mixtures thereof.

According to an embodiment of the present invention, the crosslink density in the areas with a low porosity is ≧0.05 and ≦1 and/or the crosslink density in the areas with a high porosity is ≧0.0001 and ≦0.5.

In the sense of the present invention, the term “crosslink density” means or includes especially the following definition: The crosslink density δₓ is here defined as

$${δ}_{X} = \frac{X}{L + X}$$

where X is the mole fraction of polyfunctional monomers and L the mole fraction of linear chain (=non polyfunctional) forming monomers. In a linear polymer δₓ=0, in a fully crosslinked system δₓ=1.

According to an embodiment of the present invention, the separation medium comprises linear polymers and the gel formation is enhanced by physical crosslinks due to secondary interactions between the polymer chains. Natural polymers like agarose show this behaviour and is therefore often used as a gelling material. In this case the mesh size or pore size is more determined by the concentration of the polymer in its buffer solution.

According to an embodiment of the present invention, the separation medium comprises a pre-structured polymer or inorganic materials of which the pores are determined by lithographic means.

According to an embodiment of the present invention, the separation medium comprises an assembly of structures, such as polymer spheres, brought in close contact with each other such that the pore size is determined by the shape and size of the structures.

According to an embodiment of the present invention, the inner diameter of the spheres is ≧0.2 μm and ≦10 μm, according to an embodiment of the present invention, the inner diameter of the spheres is ≧0.5 μm and ≦5 μm.

According to an embodiment of the present invention, the surface of the spheres is modified such that a special interaction between the biomolecules occurs and separation takes place on this specific interaction. The term biomolecules in the sense of this description comprises substances, which are appropriate for chromatography and which are at least partly of biological nature or are fabricated on the basis of biological substances. The term is not limited to molecules in the definition commonly given by chemistry. Further, the invention is also applicable to chemical substances.

According to an embodiment of the present invention, the areas with a high porosity are provided as interconnected wells. In the sense of the present invention, the term “well” means and/or includes especially an area where the probability that a component of the separated material concentrates itself here is higher than in the area surrounding it.

According to an embodiment of the present invention, the wells have an average width of ≧1 μm and ≦200 μm, according to an embodiment an average width of ≧10 μm and ≦100 μm, according to an embodiment an average width of ≧20 μm and ≦50 μm.

According to an embodiment of the present invention, the wells have an average length of ≧1 μm and ≦200 μm, according to an embodiment an average length of ≧10 μm and ≦100 μm, according to an embodiment an average length of ≧20 μm and ≦50 μm.

The invention furthermore relates to a method for producing a separation medium according to the present invention, comprising the steps of:

a) providing at least one monomeric substance
b) causing the monomeric substance to polymerize in defined regions in order to obtain a structured material in that way that in a preferred flow direction the flow rate is ≧2 times larger than in any direction with an angle of ≧75° and ≦105° to said preferred flow direction.

According to an embodiment of the present invention, the monomer in step a) is selected out of a group comprising acrylic acid, acrylic acid esters, acrylic acid amides methacrylic acid, methacrylic acid esters, methacrylic acid amides and mixtures thereof.

According to an embodiment of the present invention, the polymerization is achieved comprising UV-initiation. UV initiation is activated by the presence of a small amount (<6 wt %; preferable 0.01 to 3 wt %; more preferably between 0.1 and 1.5 wt %) of a photoinitiator.

The present invention furthermore relates to a device comprising a separation medium as described.

According to an embodiment of the present invention, the device is provided with at least one further glass substrate.

According to an embodiment of the present invention, the glass substrate is provided with electrodes.

According to an embodiment of the present invention, the device comprises at least one cover glass, whereby the at least one cover glass is according to an embodiment of the present invention provided with electrodes.

According to an embodiment of the present invention, the device further comprises at least one elastic layer provided with the at least one cover glass, whereby the elastic layer provides to compensate for tolerances in the height of the wells of the separation medium. According to an embodiment of the present invention, the elastic layer comprises a material selected out of the group comprising organic polymers, silicon polymers or mixtures thereof.

According to an embodiment of the present invention, the device furthermore comprises a CCD camera.

According to an embodiment of the present invention, the separation medium comprises wells whereby the wells correspond, in the ratio between the horizontal and the vertical pitch and, to a somewhat lesser extent to the shape of automated analyzer such as a charge coupled device (CCD) camera. The CCD camera is a sensor for recording images, consisting of an integrated circuit containing an array of linked, or coupled, capacitors (pixels). Under the control of an external circuit, each capacitor can transfer its electric charge to one or other of its neighbours ultimately providing information on the light intensity that initially charged each pixel. The array of capacitors forms a matrix of for instance 1280×1024 pixels organized in a period ph for the horizontal rows and pv for the vertical columns. Preferably the position of the wells in the channels is such that if the periodicity of the channels is Pv that the periodicity of the wells is given by:

$${P}_{h} = {P}_{v} \frac{{P}_{h}}{{P}_{v}} \qquad ( Eq . 1 )$$

In this way the position of a well corresponds to the position of the pixels in the CCD camera. In a special case Pₕ=pₕ and Pᵥ=pᵥ. In this case the voxels in the separation device match 1:1 with the pixels of the camera. But also Pₕ≠pₕ and Pᵥ≠pᵥ is possible as long Eq. 1 is met. In the latter case the voxels are correlated to the pixels by means of a lens system.

A separation medium, a method and/or device according to the present invention may be of use in a broad variety of systems and/or applications, amongst them one or more of the following:

biosensors used for molecular diagnostics

rapid and sensitive detection of proteins and nucleic acids in complex biological mixtures such as e.g. blood or saliva

high throughput screening devices for chemistry, pharmaceuticals or molecular biology

testing devices e.g. for DNA or proteins e.g. in criminology, for on-site testing (in a hospital), for diagnostics in centralized laboratories or in scientific research

tools for DNA or protein diagnostics for cardiology, infectious disease and oncology, food, and environmental diagnostics

tools for combinatorial chemistry

analysis devices

The aforementioned components, as well as the claimed components and the components to be used in accordance with the invention in the described embodiments, are not subject to any special exceptions with respect to their size, shape, material selection and technical concept such that the selection criteria known in the pertinent field can be applied without limitations.

### BRIEF DESCRIPTION OF THE DRAWINGS

Additional details, features, characteristics and advantages of the object of the invention are disclosed in the subclaims, the figures and the following description of the respective figures and examples, which—in an exemplary fashion—show several preferred embodiments of a separation medium as well as a device according to the invention.

FIG. 1 shows a very schematic top-view of a separation medium according to a first embodiment of the present invention prior to the injection of a sample to be chromatographed

FIG. 2 shows a very schematic top view of the separation medium of FIG. 1 after performing one electrophoresis step

FIG. 3 shows a very schematic top view of the separation medium of FIG. 1 and FIG. 2 after performing a further electrophoresis step

FIG. 4 shows a very schematic cut-out top view of a separation medium according to a second embodiment of the present invention

FIG. 5 shows a very schematic cut-out cross-sectional view of a device using a separation medium according to one embodiment of the present invention whereby the device furthermore comprises a cover glass and an elastic layer

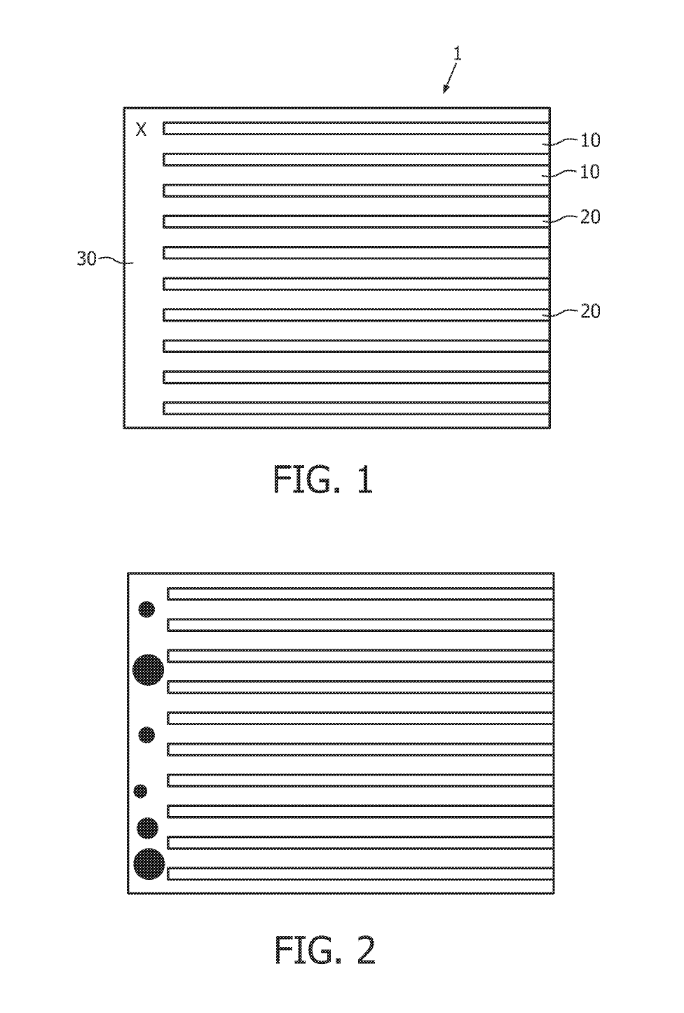

FIG. 1 shows a very schematic top-view of a separation medium 1 according to a first embodiment of the present invention prior to the injection of a sample to be chromatographed. The separation medium 1 comprises areas with a high porosity 10 which are provided somewhat in the form of channels and areas with a low porosity 20 which are provided somewhat in the form of walls. A sample to be chromatographed is then injected into the separation medium approximately at the position marked with an “x”. It should be noted that this embodiment is exemplarily only and the number of channels and walls will for most embodiments be quite higher.

FIG. 2 shows a very schematic top view of the separation medium of FIG. 1 after performing one electrophoresis step. It can be seen that the different sets of biomolecules in the sample ideally line up right before the “entrances” of the channels 10.

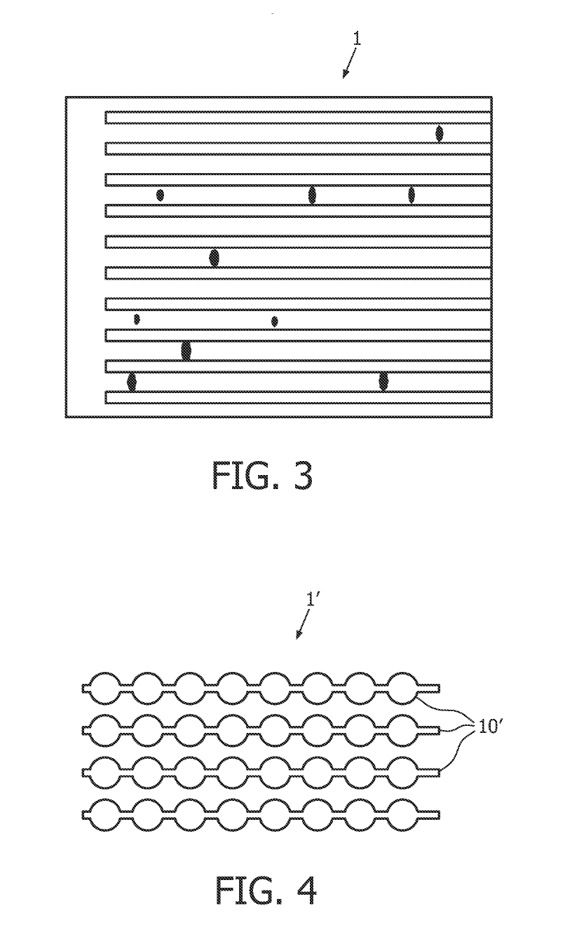

FIG. 3 shows a very schematic top view of the separation medium of FIG. 1 and FIG. 2 after performing a further electrophoresis step. In FIG. 3, it can be seen that the biomolecule once entered at certain channels are confined to that same channel, therefore the reliability of the electrophoresis is greatly improved.

FIG. 4 shows a very schematic cut-out top view of a separation medium 1′ according to a second embodiment of the present invention. In this embodiment, the areas with a high porosity 10′ are provided in the form of interconnected wells. When performing an electrophoresis as in FIG. 3, the biomolecules will in the end have a higher probability of ending up in a well, i.e. in a defined lateral position within the separation medium. Ideally, the pitch of the wells is equal to that of a CCD camera so that a picture of the separation medium can be taken and automatically be analyzed.

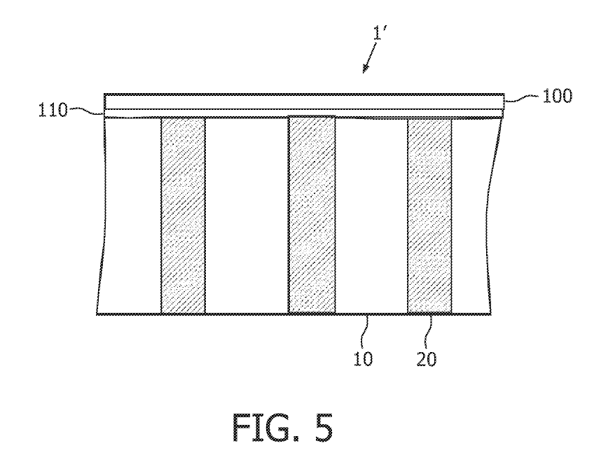

FIG. 5 shows a very schematic cross-sectional view of a device 1′ using a separation medium according to one embodiment of the present invention whereby the device furthermore comprises a cover glass 100 and an elastic layer 110. The elastic layer serves as to compensate for tolerances in the wells 20, so that a flow between the channels 10 is furthermore reduced.

### EXAMPLE I

The present invention is furthermore illustrated by the following Example I which shows—in a merely exemplarily fashion—the manufacture of a separation medium according to an embodiment of the present invention.

On a glass substrate a 50 μm thick film of a solid layer of a multifunctional epoxy provided with a photoinitiator is applied. An example of an epoxy material that is very suitable for our purpose is commercialised by MicroChem Inc. under the name of SU-8. SU-8 basically is a negative, epoxy-type, near-UV photoresist based on EPON SU-8 epoxy resin (from Shell Chemical) that has been originally developed, and patented (U.S. Pat. No. 4,882,245 (1989) and others) by IBM. The glass plates are cleaned with water/surfactant The 50 μm epoxy film is achieved by spincoating SU-8 50 (MicroChem Inc.; epoxide is dissolved and viscosity is adjusted by supplier) for 30 s with a spin speed of 3000 rpm.

The remaining solvent is removed by a 15 minutes soft bake at 95° C. and the sample is exposed at room temperature with 165 mJ·cm⁻² UV light from a mask aligner. The open areas in the mask determine where the walls of the channels will be formed (negative resist). After the UV exposure a post bake is given for 15 minutes at 95° C.

The non-exposed areas are removed by a 5 minutes rinse in propylene glycol methyl ether acetate (PGMEA) The PGMEA is subsequently removed via a 1 minute rinse in propanol-2.

### EXAMPLE II

In this Example, a cover glass with an elastic layer as described above is used.

The glass plate is provided with holes to establish filling of the channels with the separation medium and to load it with the analyte. In order to adhere the glass plate efficiently to the walls and construction areas it is coated with a thin film SU-8 obtained by spin coating of SU-8 5 for one minute at 2000 rpm. The glass plate is pressed (5000 N·.m-2) with SU-8 plane in contact with walls at a temperature of 150° C., well above the softening point of the uncured material, and exposed with UV light (300 mJ·cm-2) maintaining the whole arrangement under pressure. An even better contact adhesion was obtained by adding a small amount of glycidyl ether of bisphenol-A to the SU-8, enabling a better flow of the SU-8 before it adhered to the SU-8 walls.

The particular combinations of elements and features in the above detailed embodiments are exemplary only; the interchanging and substitution of these teachings with other teachings in this and the patents/applications incorporated by reference are also expressly contemplated. As those skilled in the art will recognize, variations, modifications, and other implementations of what is described herein can occur to those of ordinary skill in the art without departing from the spirit and the scope of the invention as claimed. Accordingly, the foregoing description is by way of example only and is not intended as limiting. The invention's scope is defined in the following claims and the equivalents thereto. Furthermore, reference signs used in the description and claims do not limit the scope of the invention as claimed.

1. A separation medium for use in chromatography, especially gel electrophoresis, whereby the separation medium is an essentially two-dimensional material which is structured in that way that in a preferred flow direction the flow rate is larger than perpendicular to said preferred flow direction.

2. The separation medium according to claim 1, whereby the separation medium is structured in that way that in the direction of ≧85° and ≦95° to the preferred flow direction alternating areas with a high porosity of ≧IO% and ≦99% and areas with a low porosity of ≧0% and ≦60% are provided.

3. The separation medium according to claim 1, whereby the areas with a high porosity form essentially parallel channels and/or the areas with a low porosity form walls along the channels.

4. A separation medium according to claim 1, whereby the width of the channels is ≧1 μm and ≦IOOO μm.

5. A separation medium according to claim 1, whereby the thickness of the walls is ≧IOO nm and ≦200 μm.

6. A separation medium according to claim 1, whereby the number of channels per mm of separation medium in cross sectional-view along an angle of ≧85° and ≦95° to the preferred flow direction is ≧IO and ≦500.

7. A separation medium according to claim 1 whereby the separation medium comprises a polyacrylic material.

8. A device comprising a separation medium according to claim 1, whereby the crosslink density in the areas with a low porosity is ≧0.05 and ≦1 and/or the crosslink density in the areas with a high porosity is ≧O.OOO1 and ≦0.5.

9. A method for producing a separation medium according to claim 1, comprising the steps of: a) providing at least one monomeric substance b) causing the monomeric substance to polymerize in defined regions in order to obtain a structured material in that way that in a preferred flow direction the flow rate is ≧2 times larger than in any direction with an angle of ≧75′ and ≦105° to said preferred flow direction.

10. A system incorporating a separation medium according to claim 1 and being used in one or more of the following applications: biosensors used for molecular diagnostics rapid and sensitive detection of proteins and nucleic acids in complex biological mixtures such as e.g. blood or saliva high throughput screening devices for chemistry, pharmaceuticals or molecular biology testing devices e.g. for DNA or proteins e.g. in criminology, for on-site testing (in a hospital), for diagnostics in centralized laboratories or in scientific research tools for DNA or protein diagnostics for cardiology, infectious disease and oncology, food, and environmental diagnostics—tools for combinatorial chemistry analysis devices.
